(19) United States
(12) Patent Application Publication
(10) Pub. No.: US 2020/0284229 A1
(43) Pub. Date: Sep. 10, 2020

(54) HIGH-PRESSURE FUEL SUPPLY PUMP

(71) Applicant: Hitachi Automotive Systems, Ltd., Hitachinaka-shi, Ibaraki (JP)

(72) Inventors: Masashi NEMOTO, Hitachinaka (JP); Satoshi USUI, Hitachinaka (JP); Hiroyuki YAMADA, Hitachinaka (JP)

(73) Assignee: Hitachi Automotive Systems, Ltd., Hitachinaka-shi, Ibaraki (JP)

(21) Appl. No.: 16/763,634

(22) PCT Filed: Nov. 8, 2018
(86) PCT No.: PCT/JP2018/041423

§ 371 Date: May 13, 2020

(30) Foreign Application Priority Data
Nov. 30, 2017 (JP) 2017-230033

(51) Int. Cl. F02M 59/46; F02M 59/36; F02M 63/00

(52) U.S. Cl. CPC F02M 59/46; F02M 59/36; F02M 63/0275; F02M 63/0077; F02M 63/005

(57) ABSTRACT

To provide a high-pressure fuel supply pump having a relief valve mechanism capable of suppressing deterioration of the seat property due to the influence of deformation caused by press-fitting while press-fitting and fixing a relief seat. To achieve this, a relief seat 201 of a relief valve mechanism 200 has, on its inner peripheral side, a seat portion 201a on which a valve 202 is seated, a small-diameter channel portion 201b formed with a smaller diameter than the valve 202 on an upstream side of the seat portion 201a, and a large-diameter channel portion 201c formed with a larger diameter than the small-diameter channel portion 201b on an upstream side of the small-diameter channel portion 201b, and, on its outer peripheral side, a fine gap portion 201d formed between the relief seat 201 and a member arranged on an outer peripheral side of the relief seat 201 at a position overlapping the small-diameter channel portion 201b in a flow direction of the fuel, and a press-fit portion 205a coming into contact with the member when the relief seat 201 is press-fitted into the member at a position overlapping the large-diameter channel portion 201c in the flow direction of the fuel.

### TECHNICAL FIELD

The present invention relates to a high-pressure fuel supply pump for pressure-feeding fuel to a fuel injection valve of an internal combustion engine.

### BACKGROUND ART

As an example of a relief valve for a fuel distribution pipe capable of securing a pressure governing function and simplifying the structure of a relief valve, while using a ball valve body by reducing differential pressure between the inside and the outside of a fuel distribution pipe, PTL 1 describes a relief valve that is prepared by assembling, in a valve body fixed to a fuel distribution pipe of a direct injection type engine, a valve element, a valve seat having a seat surface opened and closed by the valve element, and a valve spring energizing the valve element in the closing direction, in which the valve element is a ball valve element, and a restriction hole having an aperture smaller than a passage area of the valve seat is formed on a fuel passage on the downstream side of the ball valve element.

### CITATION LIST

### Patent Literature

PTL 1: JP 2000-240529 A

### SUMMARY OF INVENTION

### Technical Problem

A conventional technique of a high-pressure fuel supply pump of the present invention includes the one described in PTL 1. According to PTL 1, the external thread portion of the valve body fixed to the fuel distribution pipe by screwing is provided at a position not radially overlapping with the valve seat, and deformation of the valve seat due to distortion of the external thread portion caused by the screwing force of the valve body is prevented.

However, in the conventional technique described in PTL 1, the valve seat having a cylindrical shape is inserted and fixed to the valve seat press-fitting hole by press-fitting, and hence the valve seat is structured to be deformed by press-fitting.

When the seat is deformed in this manner, a gap may occur between the seat and the valve. If a gap occurs, the fuel cannot be cut off, the fuel on the common rail returns to the damper chamber, the pressurizing chamber, and the like, and the fuel cannot be supplied smoothly to the injector, thereby causing an engine malfunction.

In addition, even if the amount of return is very small, it becomes difficult to maintain the pressure in the common rail, and the time required for engine restart such as at idling stop increases, which affects the ride comfort, erosion is caused by cavitation when fuel passes through the seat, thereby destroying the seat and also causing an engine malfunction, and various other problems occur.

It is an object of the present invention to supply a high-pressure fuel supply pump having a relief valve mechanism capable of suppressing deterioration of the seat property due to the influence of deformation caused by press-fitting while press-fitting and fixing a relief seat.

### Solution to Problem

The present invention includes a plurality of means for solving the above problem, and one of its examples is directed to a high-pressure fuel supply pump including a relief valve mechanism configured so as to open to release a high-pressure fuel when fuel on a discharge side of a pressurizing chamber becomes equal to or greater than a set value, and having a relief seat member on which a relief valve is seated, in which the relief seat member of the relief valve mechanism has, on an inner peripheral side of the relief seat member, a seat portion on which the relief valve is seated, a small-diameter channel portion formed with a smaller diameter than the relief valve on an upstream side of the seat portion, and a large-diameter channel portion formed with a larger diameter than the small-diameter channel portion on an upstream side of the small-diameter channel portion, and on an outer peripheral side of the relief seat member, a fine gap portion formed between the relief seat member of the relief valve mechanism and a member arranged on the outer peripheral side of the relief seat member at a position overlapping the small-diameter channel portion in a flow direction of the fuel, and a press-fit portion coming into contact with the member when the relief seat member is press-fitted into the member at a position overlapping the large-diameter channel portion in the flow direction of the fuel.

Another one of the examples is directed to a high-pressure fuel supply pump including a relief valve mechanism configured so as to open to release a high-pressure fuel when fuel on a discharge side of a pressurizing chamber becomes equal to or greater than a set value, and having a relief seat member on which a relief valve is seated, in which the relief seat member of the relief valve mechanism has a seat portion on which the relief valve is seated, a thick portion formed on an upstream side of the seat portion, a thin portion formed on an upstream side of the thick portion and being thinner than the thick portion, and a press-fit portion formed on an upstream side of the thin portion and coming into contact with a member arranged on an outer peripheral side of the relief seat member when the relief seat member is press-fitted into the member.

### Advantageous Effects of Invention

According to the present invention, it is possible to suppress deterioration of the seat property due to the influence of deformation caused by press-fitting while press-fitting and fixing a relief seat. Other configurations, operations, and effects of the present invention will be described in detail in the following embodiments.

### BRIEF DESCRIPTION OF DRAWINGS

FIG. 1 illustrates a configuration diagram of an engine system to which a high-pressure fuel supply pump of the present invention is applied.

FIG. 2 is a longitudinal cross-sectional view of the high-pressure fuel supply pump of the present invention.

FIG. 3 is a horizontal cross-sectional view of the high-pressure fuel supply pump of the present invention as viewed from above.

FIG. 4 is a longitudinal cross-sectional view of the high-pressure fuel supply pump of the present invention as viewed from a different direction from FIG. 2.

FIG. 5 is an enlarged longitudinal cross-sectional view of an electromagnetic suction valve mechanism of the high-pressure fuel supply pump of the present invention, illustrating a state in which the electromagnetic suction valve mechanism is in a valve opening state.

FIG. 6 is an enlarged longitudinal cross-sectional view of a relief valve mechanism of the high-pressure fuel supply pump according to a first embodiment of the present invention, illustrating a state in which the relief valve mechanism is in a valve closing state.

FIG. 7 is an enlarged longitudinal cross-sectional view of a relief valve mechanism of a high-pressure fuel supply pump according to a second embodiment of the present invention, illustrating a state in which the relief valve mechanism is in a valve closing state.

FIG. 8 is an enlarged longitudinal cross-sectional view of the relief valve mechanism of the high-pressure fuel supply pump according to the second embodiment of the present invention, illustrating a state in which the relief valve mechanism is in a valve closing state.

FIG. 9 is an enlarged longitudinal cross-sectional view of a relief valve mechanism of a high-pressure fuel supply pump according to a third embodiment of the present invention, illustrating a state in which the relief valve mechanism is in a valve closing state.

FIG. 10 is an enlarged longitudinal cross-sectional view of a relief valve mechanism of a high-pressure fuel supply pump according to a fourth embodiment of the present invention, illustrating a state in which the relief valve mechanism is in a valve closing state.

FIG. 11 is an enlarged longitudinal cross-sectional view of a relief valve mechanism of a high-pressure fuel supply pump according to a fifth embodiment of the present invention, illustrating a state in which the relief valve mechanism is in a valve closing state.

FIG. 12 is an enlarged longitudinal cross-sectional view of a relief valve mechanism of a high-pressure fuel supply pump according to a seventh embodiment of the present invention, illustrating a state in which the relief valve mechanism is in a valve closing state.

FIG. 13 is an enlarged longitudinal cross-sectional view of a relief valve mechanism of a high-pressure fuel supply pump according to an eighth embodiment of the present invention, illustrating a state in which the relief valve mechanism is in a valve closing state.

FIG. 14 is an enlarged longitudinal cross-sectional view of a relief valve mechanism of a high-pressure fuel supply pump according to a tenth embodiment of the present invention, illustrating a state in which the relief valve mechanism is in a valve closing state.

FIG. 15 is an enlarged longitudinal cross-sectional view of a relief valve mechanism of a high-pressure fuel supply pump according to a thirteenth embodiment of the present invention, illustrating a state in which the relief valve mechanism is in a valve closing state.

FIG. 16 is a longitudinal cross-sectional view of a high-pressure fuel supply pump according to a fourteenth embodiment of the present invention.

### DESCRIPTION OF EMBODIMENTS

Embodiments of a high-pressure fuel supply pump of the present invention will be described below with reference to the drawings.

### First Embodiment

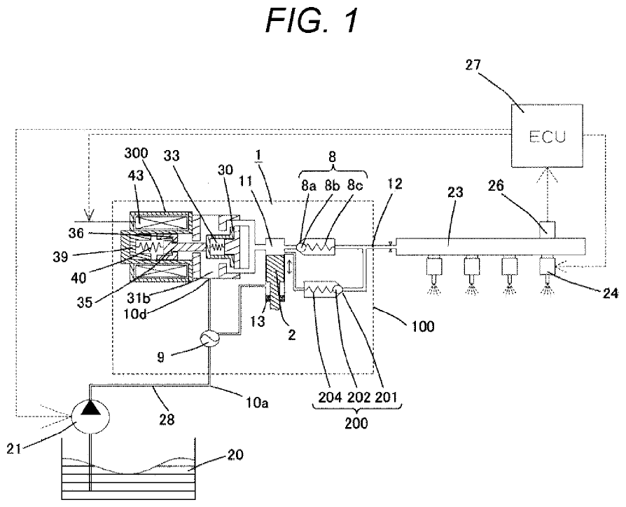

A first embodiment of a high-pressure fuel supply pump of the present invention will be described with reference to FIGS. 1 to 6. First, the system configuration and operations of the high-pressure fuel supply pump of the present invention will be described with reference to FIGS. 1 to 5.

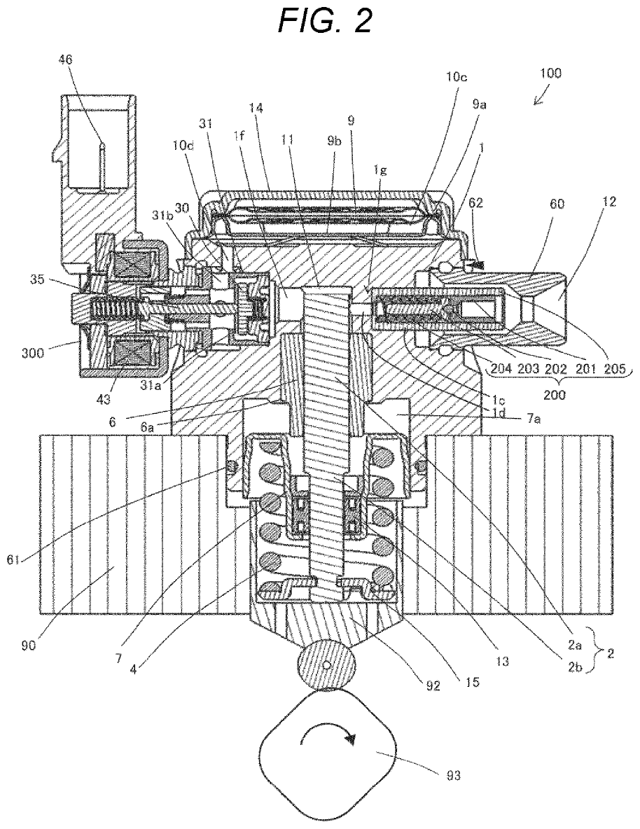

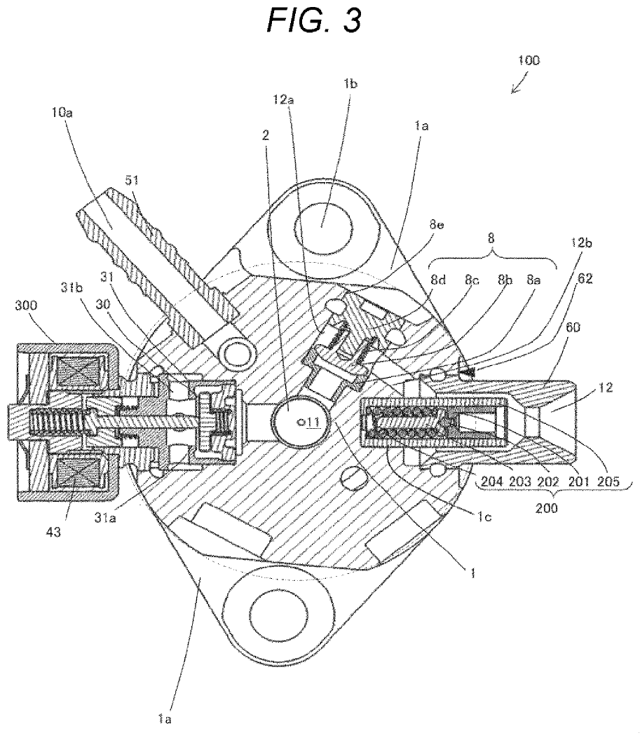

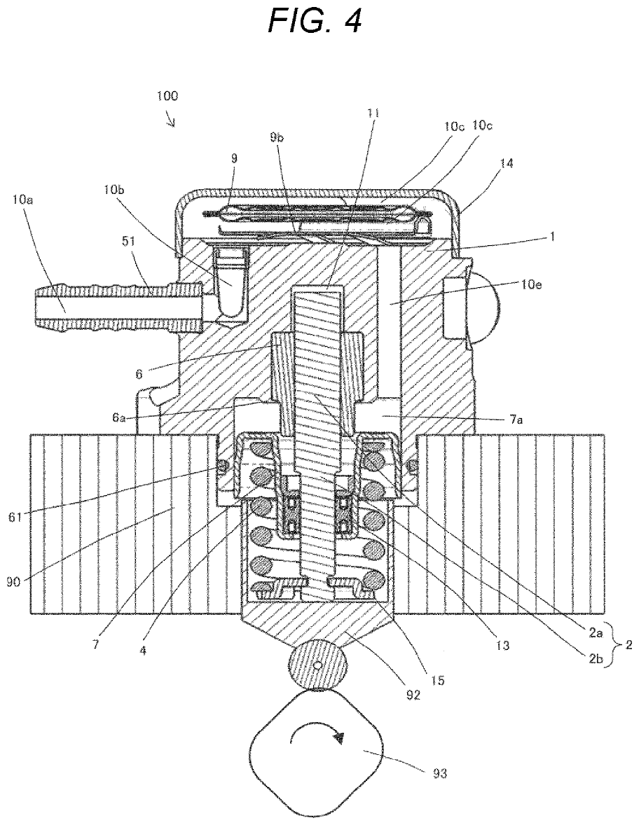

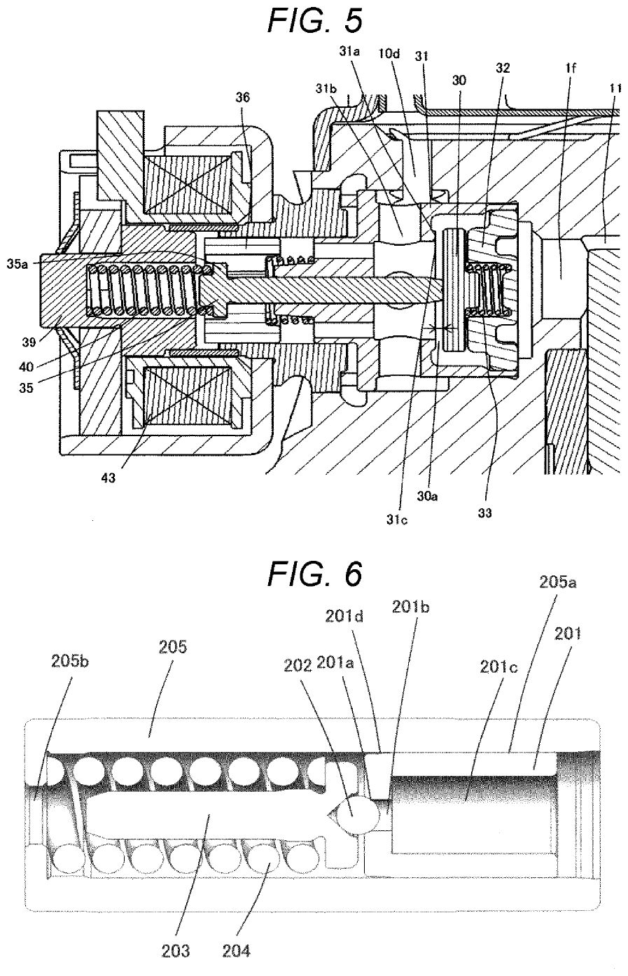

FIG. 1 is a configuration diagram of an engine system to which the high-pressure fuel supply pump is applied, FIG. 2 is a longitudinal cross-sectional view of the high-pressure fuel supply pump, FIG. 3 is a horizontal cross-sectional view of the high-pressure fuel supply pump as viewed from above, FIG. 4 is a longitudinal cross-sectional view of the high-pressure fuel supply pump as viewed from a different direction from FIG. 2, and FIG. 5 is an enlarged longitudinal cross-sectional view of an electromagnetic suction valve mechanism of the high-pressure fuel supply pump, illustrating a state in which the electromagnetic suction valve mechanism is in a valve opening state.

In FIG. 1, the portion surrounded by a broken line indicates a main body (pump body 1) of a high-pressure fuel supply pump 100. It is indicated that the mechanism and components illustrated in the broken line in FIG. 1 are integrally incorporated into the pump body 1.

Fuel in a fuel tank 20 is pumped up by a feed pump 21 on the basis of a signal from an engine control unit 27 (hereinafter referred to as ECU). This fuel is pressurized to an appropriate feed pressure and sent to a low-pressure fuel suction port 10a of the high-pressure fuel supply pump through a fuel pipe 28.

The fuel having passed through a suction joint 51 (see FIGS. 3 and 4) from the low-pressure fuel suction port 10a reaches a suction port 31b of an electromagnetic suction valve mechanism 300 constituting a variable capacity mechanism via a pressure pulsation reduction mechanism 9 and a suction passage 10d.

The fuel having flown into the electromagnetic suction valve mechanism 300 passes through a suction port opened and closed by a suction valve 30 and flows into a pressurizing chamber 11.

Here, power for reciprocating motion is given to a plunger 2 by a cam 93 (see FIG. 2) of the engine. By reciprocating motion of the plunger 2, the fuel is sucked from the suction valve 30 in a downward stroke of the plunger 2, and the fuel is pressurized in an upward stroke.

The fuel pressurized by the plunger 2 is pressure-fed via a discharge valve mechanism 8 to a common rail 23 on which a pressure sensor 26 is mounted.

Then, an injector 24 injects fuel to the engine on the basis of a signal from the ECU 27.

The present embodiment is directed to a high-pressure fuel supply pump applied to a so-called direct injection engine system in which the injector 24 injects fuel directly into a cylinder of the engine.

The high-pressure fuel supply pump 100 discharges a fuel flow rate of a desired fuel supply by a signal from the ECU 27 to the electromagnetic suction valve mechanism 300.

As illustrated in FIGS. 2 and 4, the high-pressure fuel supply pump 100 of the present embodiment is fixed in close contact with a high-pressure fuel supply pump mounting portion 90 of an internal combustion engine. More specifically, a bolt fixing hole 1b is formed in a mounting flange 1a provided in the pump body 1 of FIG. 3, and by inserting a plurality of bolts into the bolt fixing hole 1b, the mounting flange 1a is fixed in close contact with the high-pressure fuel supply pump mounting portion 90 of the internal combustion engine.

An O-ring 61 is fitted into the pump body 1 for sealing between the high-pressure fuel supply pump mounting portion 90 and the pump body 1 as illustrated in FIGS. 2 and 4, thereby preventing engine oil from leaking to the outside.

The pump body 1 is attached with a cylinder 6 that guides the reciprocating motion of the plunger 2 and forms the pressurizing chamber 11 together with the pump body 1. That is, the plunger 2 changes the volume of the pressurizing chamber by reciprocating motion inside the cylinder 6. As illustrated in FIG. 3, the electromagnetic suction valve mechanism 300 for supplying fuel to the pressurizing chamber 11 and the discharge valve mechanism 8 for discharging fuel from the pressurizing chamber 11 to a discharge passage are provided.

The cylinder 6 is press-fitted into the pump body 1 on its outer peripheral side. Furthermore, in a fixed portion 6a, the pump body 1 is deformed to the inner peripheral side to press the cylinder 6 upward in the figure, and seals the upper end surface of the cylinder 6 so that the fuel pressurized in the pressurizing chamber 11 does not leak to the low pressure side.

The lower end of the plunger 2 is provided with a tappet 92 that converts the rotational motion of the cam 93 attached to a camshaft of the internal combustion engine into a vertical motion and transmits the vertical motion to the plunger 2. The plunger 2 is crimped to the tappet 92 by a spring 4 via a retainer 15. This allows the plunger 2 to vertically reciprocate with the rotational motion of the cam 93.

Furthermore, a plunger seal 13 held at the inner peripheral lower end portion of a seal holder 7 is installed in a state of coming into slidable contact with the outer periphery of the plunger 2 at the lower portion of the cylinder 6 in the figure. Thus, when the plunger 2 slides, the fuel in an auxiliary chamber 7a is sealed to prevent the fuel from flowing into the internal combustion engine. At the same time, lubricating oil (including engine oil) that lubricates a sliding portion in the internal combustion engine is prevented from flowing into the inside of the pump body 1.

As illustrated in FIGS. 3 and 4, the suction joint 51 is attached to a side surface portion of the pump body 1 of the high-pressure fuel supply pump 100. The suction joint 51 is connected to a low-pressure pipe through which fuel from the fuel tank 20 of the vehicle is supplied and has the low-pressure fuel suction port 10a formed therein, and the fuel is supplied to the inside of the high-pressure fuel supply pump from the suction joint 51.

The fuel having passed through the low-pressure fuel suction port 10a is directed to the pressure pulsation reduction mechanism 9 through a low-pressure fuel suction port 10b illustrated in FIG. 4 vertically communicating with the pump body 1 illustrated in FIG. 3.

The pressure pulsation reduction mechanism 9 is arranged between a damper cover 14 and the upper end surface of the pump body 1, and is supported from below by a holding member 9b arranged on the upper end surface of the pump body 1. Specifically, the pressure pulsation reduction mechanism 9 is configured by stacking two diaphragms, a gas of 0.3 MPa to 0.6 MPa is sealed inside thereof, and the outer peripheral edge portion is fixed by welding. For this purpose, the pressure pulsation reduction mechanism 9 is configured to have a thin outer peripheral edge portion that becomes thicker toward the inner peripheral side.

A protrusion portion for fixing the outer peripheral edge portion of the pressure pulsation reduction mechanism 9 from below is formed on the upper surface of the holding member 9b. On the other hand, a protrusion portion serving as a holding member 9a for fixing the outer peripheral edge portion of the pressure pulsation reduction mechanism 9 from above is arranged on the lower surface of the damper cover 14, as illustrated in FIG. 2. These protrusion portions are formed in a circular shape, and the pressure pulsation reduction mechanism 9 is fixed by being sandwiched by these protrusion portions.

The damper cover 14 is press-fitted into and fixed to the outer edge portion of the pump body 1, and at this time, the holding member 9b is elastically deformed to support the pressure pulsation reduction mechanism 9. In this manner, a damper chamber 10c communicating with the low-pressure fuel suction ports 10a and 10b is formed on the upper and lower surfaces of the pressure pulsation reduction mechanism 9.

The holding members 9a and 9b form a passage through which the upper side and the lower side of the pressure pulsation reduction mechanism 9 communicate with each other, whereby the damper chamber 10c is formed on the upper and lower surfaces of the pressure pulsation reduction mechanism 9.

The fuel having passed through the damper chamber 10c then reaches the suction port 31b of the electromagnetic suction valve mechanism 300 via the suction passage 10d formed in vertical communication with the pump body 1, as illustrated in FIG. 2. The suction port 31b is formed in vertical communication with a seat member 31 forming a suction valve seat 31a.

As illustrated in FIG. 3, the discharge valve mechanism 8 provided at the outlet of the pressurizing chamber 11 is constituted by a discharge valve seat 8a, a discharge valve 8b being in contact with and separated from the discharge valve seat 8a, a discharge valve spring 8c biasing the discharge valve 8b toward the discharge valve seat 8a, and a discharge valve stopper 8d determining the stroke (movement distance) of the discharge valve 8b, and a discharge valve chamber 12a is formed between the discharge valve 8b and the discharge valve stopper 8d. The discharge valve stopper 8d and the pump body 1 are joined by welding at an abutting portion 8e, thereby cutting off the fuel from the outside.

When there is no fuel differential pressure between the pressurizing chamber 11 and a discharge valve chamber 12a, the discharge valve 8b is crimped to the discharge valve seat 8a by the biasing force of the discharge valve spring 8c, and is in a valve closing state.

It is not until the fuel pressure in the pressurizing chamber 11 becomes higher than the fuel pressure in the discharge valve chamber 12a that the discharge valve 8b opens against the discharge valve spring 8c. Then, the high-pressure fuel in the pressurizing chamber 11 is discharged to the common rail 23 through the discharge valve chamber 12a, a fuel discharge passage 12b, and a fuel discharge port 12.

When opening, the discharge valve 8b comes into contact with the discharge valve stopper 8d, thereby restricting the stroke. Accordingly, the stroke of the discharge valve 8b is appropriately determined by the discharge valve stopper 8d. This can prevent the fuel having been discharged to the discharge valve chamber 12a at high pressure from flowing back into the pressurizing chamber 11 again due to the delay in closing the discharge valve 8b caused by a stroke that is too large, and can suppress the efficiency of the high-pressure fuel supply pump 100 from decreasing.

The discharge valve 8b is guided at the outer peripheral surface of the discharge valve stopper 8d so as to move only in a stroke direction when the discharge valve 8b repeats valve opening and valve closing motions. As described above, the discharge valve mechanism 8 serves as a check valve that restricts a distribution direction of the fuel.

As described above, the pressurizing chamber 11 is constituted by the pump body 1, the electromagnetic suction valve mechanism 300, the plunger 2, the cylinder 6, and the discharge valve mechanism 8.

FIG. 5 illustrates a detailed configuration of the electromagnetic suction valve mechanism 300.

When the plunger 2 moves in the direction of the cam 93 by rotation of the cam 93 and is in a suction stroke state, the volume of the pressurizing chamber 11 increases and the fuel pressure in the pressurizing chamber 11 decreases. When the fuel pressure in the pressurizing chamber 11 becomes lower than the pressure at the suction port 31b in this stroke, the suction valve 30 becomes in a valve opening state. An opening portion 30a represents the case of the maximum opening, and at this time, the suction valve 30 comes into contact with a stopper 32.

By opening of the suction valve 30, an opening portion 31c formed in the seat member 31 opens. The fuel passes through the opening portion 31c and flows into the pressurizing chamber 11 via a hole if formed in the pump body 1 in a lateral direction. The hole if also constitutes part of the pressurizing chamber 11.

After the plunger 2 finishes the suction stroke, the plunger 2 turns into an upward motion and moves to an upward stroke. Here, an electromagnetic coil 43 remains in a non-energized state, and the magnetic biasing force does not act. A rod biasing spring 40 is set to bias a rod protrusion portion 35a protruding to the outer diameter side of a rod 35 and have a biasing force necessary and sufficient to keep the suction valve 30 opening in the non-energized state.

The volume of the pressurizing chamber 11 decreases with the upward motion of the plunger 2, but in this state, the fuel having been once sucked into the pressurizing chamber 11 is returned to the suction passage 10d through the opening portion 30a of the suction valve 30 in the valve opening state again, and hence the pressure in the pressurizing chamber 11 does not increase. This stroke is referred to as a return stroke.

In this state, when a control signal from the ECU 27 is applied to the electromagnetic suction valve mechanism 300, a current flows through the electromagnetic coil 43 via a terminal 46 (see FIG. 2). With this configuration, a magnetic attraction force acts between a magnetic core 39 and an anchor 36, and this magnetic attraction force overcomes the biasing force of the rod biasing spring 40 to bias the anchor 36, and the anchor 36 engaging with the rod protrusion portion 35a moves the rod 35 in a direction away from the suction valve 30.

At this time, the suction valve 30 is closed by the biasing force of a suction valve biasing spring 33 and the fluid force caused by the fuel flowing into the suction passage 10d.

After the valve is closed, the fuel pressure in the pressurizing chamber 11 increases with the upward motion of the plunger 2, and when the fuel pressure becomes equal to or higher than the pressure at the fuel discharge port 12, the high-pressure fuel is discharged via the discharge valve mechanism 8 and supplied to the common rail 23. This stroke is referred to as a discharge stroke.

That is, the upward stroke from the lower start point to the upper start point of the plunger 2 includes a return stroke and a discharge stroke. Then, an amount of the high-pressure fuel to be discharged can be controlled by controlling the timing of energizing the electromagnetic coil 43 of the electromagnetic suction valve mechanism 300.

If the timing of energizing the electromagnetic coil 43 is made earlier, the ratio of the return stroke in the compression stroke is small and the ratio of the discharge stroke is large. That is, less fuel is returned to the suction passage 10d and more fuel is discharged at high pressure.

On the other hand, if the energization timing is delayed, the ratio of the return stroke is large and the ratio of the discharge stroke is small in the compression stroke. That is, more fuel is returned to the suction passage 10d, and less fuel is discharged at high pressure. The timing of energizing the electromagnetic coil 43 is controlled by a command from the ECU 27.

By controlling the timing of energizing the electromagnetic coil 43 as described above, the amount of fuel discharged at high pressure can be controlled to an amount required by the internal combustion engine.

As illustrated in FIG. 2, the damper chamber 10c is provided with the pressure pulsation reduction mechanism 9 that reduces spread, to the fuel pipe 28, of pressure pulsation generated in the high-pressure fuel supply pump. When the fuel having once flown into the pressurizing chamber 11 is returned to the suction passage 10d through the suction valve 30 in the valve opening state again for the purpose of capacity control, pressure pulsation is generated in the damper chamber 10c by the fuel having been returned to the suction passage 10d. However, the pressure pulsation reduction mechanism 9 provided in the damper chamber 10c is formed of a metal diaphragm damper in which two corrugated disk-shaped metal plates are stuck on its outer periphery and an inert gas such as argon is injected inside, and the pressure pulsation is absorbed and reduced by expansion and contraction of the metal damper.

As illustrated in FIGS. 2 and 4, the plunger 2 has a large-diameter portion 2a and a small-diameter portion 2b, and the volume of the auxiliary chamber 7a increases and decreases by the reciprocating motion of the plunger 2. The auxiliary chamber 7a is in communication with the damper chamber 10c through a fuel passage 10e. The fuel flows from the auxiliary chamber 7a to the damper chamber 10c when the plunger 2 moves downward, and from the damper chamber 10c to the auxiliary chamber 7a when the plunger 2 moves upward.

This can reduce the fuel flow rate into and out of the pump in the suction stroke or the return stroke of the pump, and provides a function of reducing the pressure pulsation generated inside the high-pressure fuel supply pump.

Next, a relief valve mechanism 200 illustrated in FIGS. 2 and 3 will be described.

The relief valve mechanism 200 includes a relief seat 201, a valve 202, a valve holder 203, a relief spring 204, and a relief body 205.

The relief seat 201 is provided with a tapered seat portion 201a (see FIG. 6).

The valve 202 is loaded by the load of the relief spring 204 via the valve holder 203, pressed to the seat portion 201a, and cuts off the fuel in cooperation with the seat portion 201a. The valve opening pressure of the valve 202 is determined by the biasing force of the relief spring 204.

The relief seat 201 is press-fitted into and fixed to the relief body 205, and is a mechanism that adjusts the biasing force of the relief spring 204 in accordance with the position of the press-fitting and fixing.

When the fuel in the pressurizing chamber 11 is pressurized and the discharge valve 8b opens, the high-pressure fuel in the pressurizing chamber 11 is discharged from the fuel discharge port 12 through the discharge valve chamber 12a and the fuel discharge passage 12b.

The fuel discharge port 12 is formed in a discharge joint 60, and the discharge joint 60 is welded and fixed to the pump body 1 at a welded portion 62 to secure a fuel passage. In the present embodiment, the relief valve mechanism 200 is arranged in a space formed inside the discharge joint 60. That is, the outermost-diameter portion of the relief valve mechanism 200 (outermost-diameter portion of the relief body 205 in the present embodiment) is arranged on the inner peripheral side relative to the inner-diameter portion of the discharge joint 60, and the relief valve mechanism 200 is arranged such that at least a part thereof axially overlaps the discharge joint 60 as the pump body 1 is viewed from the upper side.

With this configuration, even if the shape of the discharge joint 60 is changed, it is not necessary to change the shape of the relief valve mechanism 200 in accordance with the change, thereby allowing the cost to be reduced.

That is, in the present embodiment, as illustrated in FIG. 2, a first hole 1c (lateral hole) is formed in a direction orthogonal to a plunger axial direction (lateral direction) from the outer peripheral surface of the pump body 1 toward the inner peripheral side. Then, the relief valve mechanism 200 is arranged by press-fitting the relief body 205 into the first hole 1c.

Then, in the present embodiment, the pump body 1 is provided with a second hole 1d (lateral hole), in communication with the first hole 1c, through which the fuel in the discharge side channel pressurized in the pressurizing chamber 11 and discharged from the discharge valve 8b is returned to the pressurizing chamber 11 when the relief valve mechanism 200 opens.

Specifically, when the pressure of the fuel on the discharge side of the pressurizing chamber 11 in the common rail 23 or the like becomes equal to or greater than a set value, the valve 202 opens and the discharge side channel (fuel discharge port 12) and the internal space of the relief valve mechanism 200 communicate with each other. The valve holder 203 and the relief spring 204 are arranged in the internal space. A hole 205b (see FIG. 6) is formed in the center portion as the relief body 205 is viewed in the axial direction of the relief valve mechanism 200, thereby connecting the internal space of the relief body 205 and a relief passage 1g formed by the second hole 1d.

When the valve 202 opens, fuel in the internal space of the relief body 205 flows into the pressurizing chamber 11 through the hole 205b in the center portion of the relief body 205 and the relief passage 1g.

At the time of the pressurizing step, a pressure loss occurs due to the discharge valve mechanism 8 and the fuel discharge passage 12b formed between the fuel discharge port 12 and the pressurizing chamber 11 at the time of fuel discharge, and an overshoot in which the pressure in the pressurizing chamber 11 becomes abnormally higher than the pressure in the fuel discharge port 12 may occur. Due to this overshoot, the pressure at the fuel discharge port 12 at the time of the pressurizing step greatly fluctuates.

However, in the case of the configuration as in the present embodiment in which abnormally high-pressure fuel is relieved to the high-pressure side, although the pressure at the fuel discharge port 12 increases as described above at the time of the pressurizing step, the pressure in the pressurizing chamber 11 also increases because the outlet of the relief valve mechanism 200 is the pressurizing chamber 11, and the differential pressure between the inlet and outlet of the relief valve mechanism 200 does not become equal to or higher than the set pressure of the valve 202 by the relief spring 204, and hence the valve 202 does not open.

On the other hand, since fuel is not discharged into the common rail 23 at the time of the suction step and the return step, the pressure at the fuel discharge port 12 does not greatly fluctuate. Therefore, it is not necessary to have a relief valve set load in consideration of the overshoot in which the pressure in the pressurizing chamber 11 becomes abnormally higher than the pressure in the fuel discharge port 12. When the relief valve set load is increased, the pressure-resistant design of the high-pressure area such as the common rail 23 needs to be increased accordingly, and the fuel consumption tends to deteriorate due to an increase in weight. Thus, returning the fuel to the pressurizing chamber 11 has an effect of suppressing the fuel consumption.

When the high-pressure fuel supply pump operates normally, the fuel pressurized by the pressurizing chamber 11 passes through the fuel discharge passage 12b and is discharged at a high pressure from the fuel discharge port 12.

Immediately after the start of the pressurizing stroke, the pressure in the pressurizing chamber 11 sharply rises to be higher than the pressure in the common rail 23, and accordingly, the discharge valve 8b closed by the common rail pressure opens. Accordingly, the pressure at the fuel discharge port 12 also increases.

At this time, the pressure is measured by the pressure sensor 26 mounted in the common rail 23, and by adjusting the discharge amount of the high-pressure fuel supply pump and the discharge amount of the injector 24 on the basis of the measurement result, the pressure in the common rail 23 is adjusted to become the target pressure while fluctuating.

In the present embodiment, the minimum value of load generated in the valve 202 by the pressure in the relief spring 204 and the pressurizing chamber 11 is set to be larger than the maximum value of load generated in the valve 202 by the pressure in the common rail 23. That is, the pressure at the fuel discharge port 12, which is the inlet of the relief valve mechanism 200, is set not to exceed the valve opening pressure, and the relief valve mechanism 200 does not open.

Next, a case in which an abnormally high-pressure fuel is generated will be described.

When the pressure at the fuel discharge port 12 becomes abnormally high due to failure of the electromagnetic suction valve mechanism 300 of the high-pressure fuel supply pump or the like, and becomes higher than the valve opening pressure of the relief valve mechanism 200, the abnormally high-pressure fuel is relieved to the pressurizing chamber 11 via the relief passage 1g. With this configuration, the pressure at the fuel discharge port 12 becomes equal to or less than a predetermined value even if a failure or the like of the electromagnetic suction valve mechanism 300 occurs, and hence the common rail 23 or the like is not damaged by high pressure.

Next, the configuration of the relief valve mechanism 200 will be described in detail with reference to FIG. 6. FIG. 6 is an enlarged longitudinal cross-sectional view of the relief valve mechanism of the high-pressure fuel supply pump of the present embodiment, and a view illustrating a state in which the relief valve mechanism is in a valve closing state.

In the relief valve mechanism 200 of the present embodiment, in the flow direction of fuel, that is, in the axial direction, the inner peripheral side of the relief seat 201 is provided with the seat portion 201a on which the valve 202 is seated, a small-diameter channel portion 201b formed with a small diameter on the upstream side of the seat portion 201a, and a large-diameter channel portion 201c formed with a larger diameter than the small-diameter channel portion 201b on the upstream side of the small-diameter channel portion 201b.

Furthermore, on the outer peripheral side of the relief seat 201, a fine gap portion 201d that ensures a fine volume in the radial direction between the relief seat 201 and the relief body 205 is formed at a position axially overlapping the small-diameter channel portion 201b, and a press-fit portion 205a press-fitted into the inner peripheral portion of the relief body 205 is formed at a position axially overlapping the large-diameter channel portion 201c.

If a gap occurs between the seat portion 201a and the valve 202, the fuel cannot be cut off. In this case, the fuel in the common rail 23 passes through the seat portion 201a and the second hole 1d, and returns to the pressurizing chamber 11. As a result, fuel cannot be supplied to the injector 24, thereby causing an engine malfunction. In addition, even if the amount of return to the pressurizing chamber 11 is very small, it becomes difficult to maintain the pressure in the common rail 23, and the time required for engine restart such as at idling stop increases, which affects the ride comfort, erosion is caused by cavitation when fuel passes through the seat portion 201a, thereby destroying the seat portion 201a and also causing an engine malfunction.

On the other hand, the relief valve mechanism 200 of the present embodiment can be configured such that the seat portion 201a and the press-fit portion 205a are axially separated by the fine gap portion 201d. Therefore, deformation of the relief seat 201 caused by press-fitting of the relief valve mechanism 200 into the pump body 1 is prevented from being transmitted to the seat portion 201a, and a gap does not occur between the seat portion 201a and the valve 202 due to deformation of the seat portion 201a.

Therefore, it is possible to provide a high-pressure fuel supply pump having the relief valve mechanism 200 capable of reliably cutting off fuel, achieving residual pressure retention characteristics, and suppressing damage due to cavitation to the seat portion 201a. Furthermore, it is possible to provide a high-pressure fuel supply pump capable of coping with a further increase in fuel pressure in the future.

### Second Embodiment

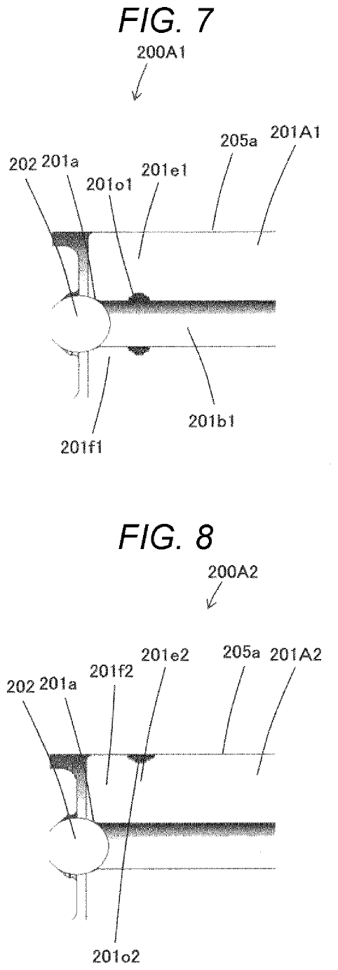

A high-pressure fuel supply pump of a second embodiment of the present invention will be described with reference to FIGS. 7 and 8. The same components as those in the first embodiment are denoted by the same reference numerals, and description thereof is omitted. FIGS. 7 and 8 are enlarged longitudinal cross-sectional views of a relief valve mechanism of the high-pressure fuel supply pump of the present embodiment, and views illustrating a state in which the relief valve mechanism is in a valve closing state.

The high-pressure fuel supply pump of the present embodiment illustrated in FIG. 7 is the same as the high-pressure fuel supply pump of the second embodiment except that a relief seat 201A1 of a relief valve mechanism 200A1 is different in shape from the relief seat 201 of the first embodiment.

As illustrated in FIG. 7, the relief seat 201A1 of the relief valve mechanism 200A1 of the present embodiment is provided with the seat portion 201a on which the valve 202 is seated, a small-diameter channel portion 201b1 having an annular recess portion 201o1 formed on a channel wall surface, a thick portion 201f1 formed on the downstream side of the recess portion 201o1 and the upstream side of the seat portion 201a, a thin portion 201e1 formed in the portion of the recess portion 201o1 on the upstream side of the thick portion 201f1 and being thinner than the thick portion 201f1, and the press-fit portion 205a formed on the upstream side of the recess portion 201o1 and the thin portion 201e1 and to be press-fitted into the inner peripheral portion of the relief body 205.

This configuration allows deformation generated when the relief seat 201A1 is press-fitted and fixed to the relief body 205 to be absorbed by the low-rigidity thin portion 201e, and deformation not to be transmitted to the high-rigidity thick portion 201f1 and the seat portion 201a provided in the thick portion 201f1. Therefore, it is possible to obtain a deformation suppressing effect higher than that of the first embodiment.

The relief seat of the relief valve mechanism of the high-pressure fuel supply pump of the present embodiment is not limited to have the shape illustrated in FIG. 7. As illustrated in FIG. 8, by forming an annular recess portion 201o2 on an outer peripheral surface of a relief seat 201A2, it is possible to provide a high-pressure fuel supply pump including a relief valve mechanism 200A2 having a low-rigidity thin portion 201e2, a high-rigidity thick portion 201f2, and a relief seat 201A2 having such a shape that deformation is not transmitted to the seat portion 201a included in the thick portion 201f2.

### Third Embodiment

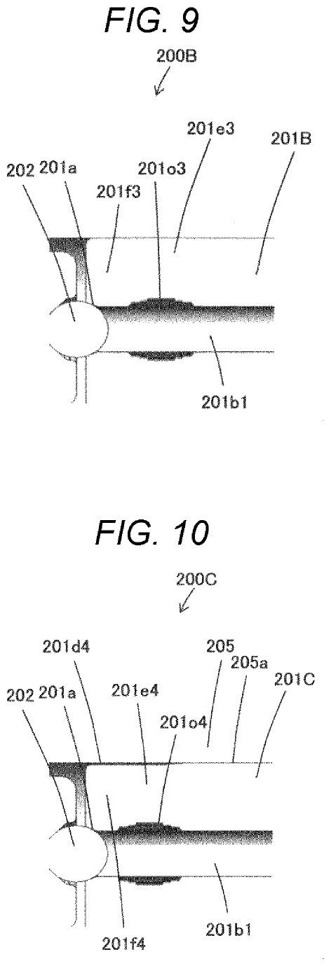

A high-pressure fuel supply pump of a third embodiment of the present invention will be described with reference to FIG. 9. FIG. 9 is an enlarged longitudinal cross-sectional view of a relief valve mechanism of the high-pressure fuel supply pump of the present embodiment, and a view illustrating a state in which the relief valve mechanism is in a valve closing state.

The high-pressure fuel supply pump of the present embodiment illustrated in FIG. 9 is the same as the high-pressure fuel supply pump of the first embodiment except that a relief seat 201B of a relief valve mechanism 200B is different in shape from the relief seat 201A1 of the second embodiment.

As illustrated in FIG. 9, in the relief valve mechanism 200B of the present embodiment, an annular recess portion 201o3 is formed on a channel wall surface of the small-diameter channel portion 201b1 so that the axial length of a thin portion 201e3 is longer than the axial length of a thick portion 201f3.

With this configuration, deformation in the thin portion 201e3 becomes larger, and hence it is possible to obtain a deformation suppressing effect higher than that of the second embodiment.

### Fourth Embodiment

A high-pressure fuel supply pump of a fourth embodiment of the present invention will be described with reference to FIG. 10. FIG. 10 is an enlarged longitudinal cross-sectional view of a relief valve mechanism of the high-pressure fuel supply pump of the present embodiment, and a view illustrating a state in which the relief valve mechanism is in a valve closing state.

The high-pressure fuel supply pump of the present embodiment illustrated in FIG. 10 is the same as the high-pressure fuel supply pump of the second embodiment except that a relief seat 201C of a relief valve mechanism 200C is different in shape from the relief seat 201A1 of the second embodiment.

As illustrated in FIG. 10, in the relief valve mechanism 200C of the present embodiment, the relief seat 201C has a thin portion 201e4 formed by an annular recess portion 201o4, a fine gap portion 201d4 formed between an outer peripheral portion of a thick portion 201f4 and the inner peripheral portion of the relief body 205, and the fine gap portion 201d4 also formed between the outer peripheral portion of the thin portion 201e4 and the inner peripheral portion of the relief body 205.

The high-pressure fuel supply pump of the present embodiment also gives the same operations and effects as those of the high-pressure fuel supply pump of the second embodiment.

Furthermore, the axial length of the fine gap portion 201d4 increases, but by making the portion thereof a fine gap, it is possible to reduce the volume of the portion spatially connected with the pressurizing chamber 11. This allows the volume pressurized by the plunger 2 at the time of the discharge step to be reduced, and the discharge amount efficiency at the time of high-pressure discharge to be increased. The increase in the discharge amount efficiency allows the energy required for raising the plunger 2 to be reduced, which can also contribute to an improvement in fuel consumption and reduction in CO₂.

### Fifth Embodiment

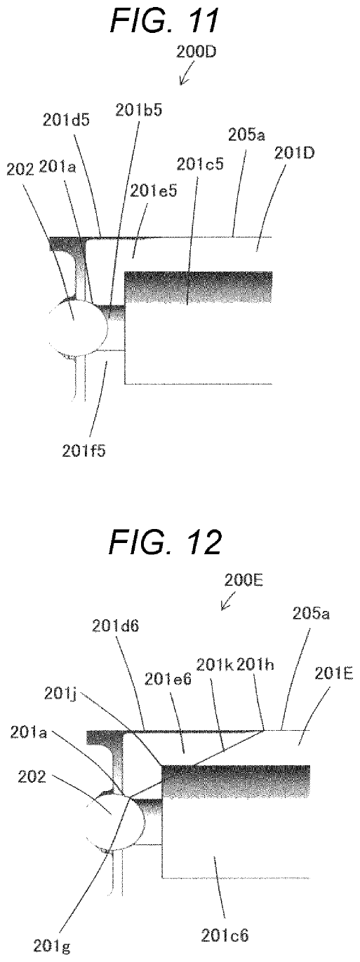

A high-pressure fuel supply pump of a fifth embodiment of the present invention will be described with reference to FIG. 11. FIG. 11 is an enlarged longitudinal cross-sectional view of a relief valve mechanism of the high-pressure fuel supply pump of the present embodiment, and a view illustrating a state in which the relief valve mechanism is in a valve closing state.

The high-pressure fuel supply pump of the present embodiment illustrated in FIG. 11 is the same as the high-pressure fuel supply pump of the second embodiment except that a relief seat 201D of a relief valve mechanism 200D is different in shape from the relief seat 201A1 of the second embodiment.

As illustrated in FIG. 11, the relief seat 201D of the relief valve mechanism 200D of the present embodiment has a small-diameter channel portion 201b5 formed with a small diameter on an inner peripheral side of a thick portion 201f5, and a large-diameter channel portion 201c5 formed with a larger diameter than the small-diameter channel portion 201b5 on the inner peripheral side of the thin portion 201e5 and the inner peripheral side of the press-fit portion 205a. Furthermore, on the outer peripheral side of the relief seat 201D, a fine gap portion 201d5 is formed at a position axially overlapping both the small-diameter channel portion 201b5 and the large-diameter channel portion 201c5, and the large-diameter channel portion 201c5 is formed on the inner peripheral side of the thin portion 201e5 and the inner peripheral side of the press-fit portion 205a.

The high-pressure fuel supply pump of the present embodiment also gives the same operations and effects as those of the high-pressure fuel supply pump of the second embodiment.

Furthermore, by forming the large-diameter channel portion 201c5 on the inner peripheral side of the thin portion 201e5 and the inner peripheral side of the press-fit portion 205a, the gap between the outer peripheral portion of the thick portion 201f5 and the inner peripheral portion of the relief body 205 can be made a fine gap when the thin portion 2015 is formed, and the volume of the portion spatially connected with the pressurizing chamber 11 can be reduced. This allows the volume pressurized by the plunger 2 at the time of the discharge step to be reduced, and the discharge amount efficiency at the time of high-pressure discharge to be increased.

The increase in the discharge amount efficiency allows the energy required for raising the plunger 2 to be reduced, which can contribute to an improvement in fuel consumption and reduction in CO₂.

### Sixth Embodiment

A high-pressure fuel supply pump of a sixth embodiment of the present invention will be described with reference to FIG. 11, which is the same as the fifth embodiment.

In the high-pressure fuel supply pump of the present embodiment, the relief seat 201D of the relief valve mechanism 200D is formed such that the interval of the fine gap portion 201d5 formed between the outer peripheral portion of the thick portion 201f5 and the inner peripheral portion of the relief body 205 is equal to or less than 0.2 mm.

Other points are the same as those of the high-pressure fuel supply pump of the fifth embodiment, and the same operations and effects as those of the fifth embodiment can also be obtained by the present embodiment.

Furthermore, by making the distance of the fine gap portion 201d5 equal to or less than 0.2 mm, it is possible to cause the outer peripheral portion of the thick portion 201f5 and the inner peripheral portion of the relief body 205 to come into contact with each other when the relief seat 201D is press-fitted and fixed to the relief body 205. This gives an effect that the relief seat 201D is inclined with respect to the relief body 205 at the time of press-fitting and galling hardly occurs.

### Seventh Embodiment

A high-pressure fuel supply pump of a seventh embodiment of the present invention will be described with reference to FIG. 12. FIG. 12 is an enlarged longitudinal cross-sectional view of a relief valve mechanism of the high-pressure fuel supply pump of the present embodiment, and a view illustrating a state in which the relief valve mechanism is in a valve closing state.

The high-pressure fuel supply pump of the present embodiment illustrated in FIG. 12 is the same as the high-pressure fuel supply pump of the first embodiment except that a relief seat 201E of a relief valve mechanism 200E is different in shape from the relief seat 201 of the first embodiment.

As illustrated in FIG. 12, the relief seat 201E of the relief valve mechanism 200E of the present embodiment is configured such that, in an axial cross-sectional view, a seat-side end portion 201j of the outer peripheral portion of a large-diameter channel portion 201c6 is positioned on the outer peripheral side with respect to a straight line 201k drawn from a seal portion 201g where the seat portion 201a and the valve 202 are in contact with each other to a seat-side end portion 201h of the press-fit portion 205a press-fitted into the inner peripheral portion of the relief body 205.

The high-pressure fuel supply pump of the present embodiment also gives the same operations and effects as those of the high-pressure fuel supply pump of the first embodiment.

Furthermore, the deformation amount in a thin portion 201e6 for obtaining the deformation suppressing effect in the seat portion 201a is defined by the radial thickness and the axial length of the thin portion 201e6, thereby allowing the deformation suppressing effect to be easily defined.

### Eighth Embodiment

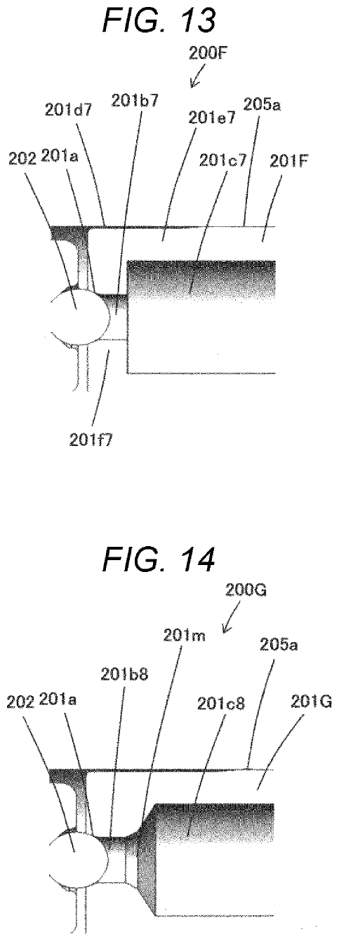

A high-pressure fuel supply pump of an eighth embodiment of the present invention will be described with reference to FIG. 13. FIG. 13 is an enlarged longitudinal cross-sectional view of a relief valve mechanism of the high-pressure fuel supply pump of the present embodiment, and a view illustrating a state in which the relief valve mechanism is in a valve closing state.

The high-pressure fuel supply pump of the present embodiment illustrated in FIG. 13 is the same as the high-pressure fuel supply pump of the first embodiment except that a relief seat 201F of a relief valve mechanism 200F is different in shape from the relief seat 201 of the first embodiment.

As illustrated in FIG. 13, the relief seat 201F of the relief valve mechanism 200F of the present embodiment is configured such that the axial length of a small-diameter channel portion 201b7 is smaller than the axial length of a fine gap portion 201d7.

With this configuration, deformation in a thin portion 201e7 becomes larger, and it is possible to obtain a deformation suppressing effect higher than that of the first embodiment.

### Ninth Embodiment

A high-pressure fuel supply pump of a ninth embodiment of the present invention will be described with reference to FIG. 13, which is the same as the eighth embodiment.

In the high-pressure fuel supply pump of the present embodiment, the relief seat 201F of the relief valve mechanism 200F is configured such that the axial length of a large-diameter channel portion 201c7 is larger than the axial length of the press-fit portion 205a.

With this configuration, the thin portion 201e7 is formed between the press-fit portion 205a and the thick portion 201f7 in the axial direction, and it is possible to obtain a deformation suppressing effect higher than that of the eighth embodiment.

### Tenth Embodiment

A high-pressure fuel supply pump of a tenth embodiment of the present invention will be described with reference to FIG. 14. FIG. 14 is an enlarged longitudinal cross-sectional view of a relief valve mechanism of the high-pressure fuel supply pump of the present embodiment, and a view illustrating a state in which the relief valve mechanism is in a valve closing state.

The high-pressure fuel supply pump of the present embodiment illustrated in FIG. 14 is the same as the high-pressure fuel supply pump of the first embodiment except that a relief seat 201G of a relief valve mechanism 200G is different in shape from the relief seat 201 of the first embodiment.

As illustrated in FIG. 14, the relief seat 201G of the relief valve mechanism 200G of the present embodiment is configured such that a small-diameter channel portion 201b8 and a large-diameter channel portion 201c8 are connected via a tapered expansion portion 201m, and the channel diameter expands from the small-diameter channel portion 201b8 toward the large-diameter channel portion 201c8.

This provides the relief valve mechanism 200 of the high-pressure fuel supply pump of the embodiment 1 with an effect that fluid separation due to a channel change and channel reduction due to the separation can be suppressed at an intersection portion when fuel flows from the large-diameter channel portion 201c8 to the small-diameter channel portion 201b8. Furthermore, it is possible to suppress the fluid separation and the pressure loss at the intersection portion between the large-diameter channel portion 201c8 and the small-diameter channel portion 201b8, and it is possible to stabilize the valve opening and closing behavior of the valve 202. In addition, by suppressing the pressure loss and stabilizing the valve opening and closing behavior of the valve 202, it is possible to suppress the pressure loss in the entire relief valve mechanism 200G generated when the fuel flows through the relief valve mechanism 200G.

### Eleventh Embodiment

A high-pressure fuel supply pump of an eleventh embodiment of the present invention will be described with reference to FIG. 14, which is the same as the tenth embodiment.

In the high-pressure fuel supply pump of the present embodiment, the relief seat 201G of the relief valve mechanism 200G is configured such that the expansion portion 201m is configured in a tapered shape and the taper angle of the expansion portion 201m is larger than the seat angle of the seat portion 201a.

Here, the angle in the present embodiment is the inclination amount in a vertical direction when a flow direction of the high-pressure fuel is 0 degrees.

The seat angle of the seat portion 201a is desirably made small in order to suppress fluid separation generated at the intersection portion with the small-diameter channel portion 201b8 on the upstream side and cavitation due to the separation, and to suppress an influence on the valve 202.

On the other hand, in the expansion portion 201m, by the taper angle of the expansion portion 201m being larger than the seat angle of the seat portion 201a, the flow is regulated in the small-diameter channel portion 201b8 even if fluid separation occurs at the intersection portion between the expansion portion 201m and the small-diameter channel portion 201b8, and hence the influence on the valve 202 can be reduced.

Furthermore, the increase in the taper angle of the expansion portion 201m allows the axial length to be shortened, the axial lengths of the relief seat 201G, the relief valve mechanism 200G, and the discharge joint 60 to be reduced, and the degree of freedom of the engine layout to be increased.

### Twelfth Embodiment

A high-pressure fuel supply pump of a twelfth embodiment of the present invention will be described with reference to FIG. 14, which is the same as the tenth embodiment.

In the high-pressure fuel supply pump of the present embodiment, the relief seat 201G of the relief valve mechanism 200G of the high-pressure fuel supply pump is configured such that the axial length of the expansion portion 201m is smaller than the axial length of the small-diameter channel portion 201b8.

This allows the flow to be regulated in the small-diameter channel portion 201b8 even if fluid separation occurs at the intersection portion between the expansion portion 201m and the small-diameter channel portion 201b8, and the influence on the valve 202 to be reduced as compared with the eleventh embodiment.

### Thirteenth Embodiment

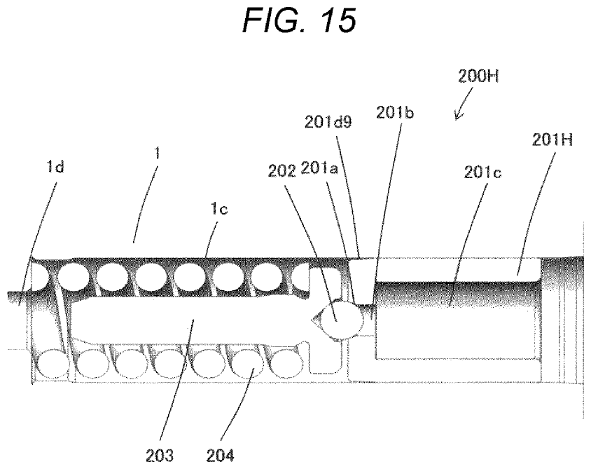

A high-pressure fuel supply pump of a thirteenth embodiment of the present invention will be described with reference to FIG. 15.

Unlike the first to twelfth embodiments described above, a relief valve mechanism 200H of the high-pressure fuel supply pump of the present embodiment is configured by inserting the valve 202, the valve holder 203, and the relief spring 204 into the first hole 1c provided in the pump body 1 without using the relief body 205, and by directly press-fitting a relief seat 201H also into the first hole 1c.

Like the relief seat 201 of the first embodiment, the relief seat 201H in FIG. 15 has a shape in which, on the outer peripheral side of the relief seat 201H, a fine gap portion 201d9 that ensures a fine volume in the radial direction between the relief seat 201H and the relief body 205 is formed at a position axially overlapping the small-diameter channel portion 201b, and the press-fit portion 205a press-fitted into the inner peripheral portion of the relief body 205 is formed at a position axially overlapping the large-diameter channel portion 201c. However, the relief seat 201H can have the same shape as that of the relief seat of any of the second to twelfth embodiments.

The effects obtained by the high-pressure fuel supply pump of the present embodiment are the same as those of the high-pressure fuel supply pumps of the first to twelfth embodiments described above.

### Fourteenth Embodiment

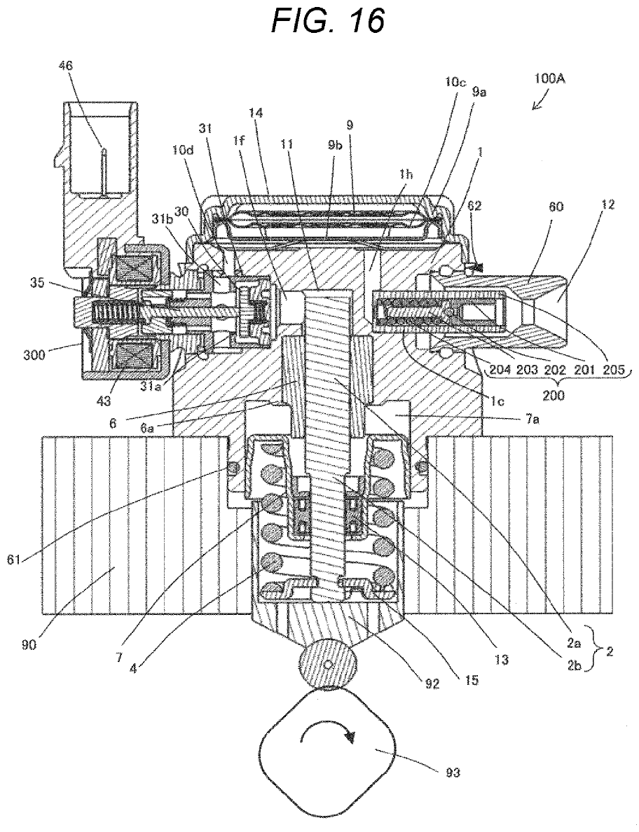

A high-pressure fuel supply pump of a fourteenth embodiment of the present invention will be described with reference to FIG. 16. FIG. 16 is a view illustrating a longitudinal cross-sectional view of the high-pressure fuel supply pump of the present embodiment.

In a high-pressure fuel supply pump 100A of the present embodiment, as illustrated in FIG. 16, the relief valve mechanism 200 is configured to return fuel to the damper chamber 10c via a second hole 1h (vertical hole) when the pressure in the common rail 23 becomes equal to or greater than a set value.

In this case, since the pressurizing chamber 11 and the relief valve mechanism 200 are not spatially connected, it is possible to reduce the volume spatially connected with the pressurizing chamber 11. This allows the volume pressurized by the plunger 2 at the time of the discharge step to be reduced, and the discharge amount efficiency at the time of high-pressure discharge to be increased. The increase in the discharge amount efficiency allows the energy required for raising the plunger 2 to be reduced, which can contribute to an improvement in fuel consumption and reduction in CO₂.

### Others

The present invention is not limited to the above-described embodiments, and includes various modifications.

The embodiments described above have been described in detail for an easy-to-understand explanation of the present invention, and are not necessarily limited to those having all the described configurations.

It is also possible to replace part of the configuration of one embodiment with the configuration of another embodiment, and it is also possible to add the configuration of another embodiment to the configuration of one embodiment. It is further possible to add, delete, or replace other configurations for part of the configuration of each embodiment.

### REFERENCE SIGNS LIST

1 pump body
1c first hole
1d second hole
1g relief passage
1h second hole
8 discharge valve mechanism
8a discharge valve seat
8b discharge valve
8d discharge valve stopper
8e abutting portion
9 pressure pulsation reduction mechanism
9a holding member
9b holding member
10a low-pressure fuel suction port
10b low-pressure fuel suction port
10c damper chambers
10d suction passage
10e fuel passage
11 pressurizing chamber
12 fuel discharge port
12a discharge valve chamber
12b fuel discharge passage
23 common rail
24 injector
26 pressure sensor
100, 100A high-pressure fuel supply pump
200, 200A1, 200A2, 200B, 200C, 200D, 200E, 200F, 200G, 200H relief valve mechanism
201, 201A1, 201A2, 201B, 201C, 201D, 201E, 201F, 201G, 201H relief seat (relief seat member)
201a seat portion
201b, 201b1, 201b5, 201b7, 201b8 small-diameter channel portion
201c, 201c5, 201c6, 201c7, 201c8 large-diameter channel portion
201d, 201d4, 201d5, 201d7, 201d9 fine gap portion
201e1, 201e2, 201e3, 201e4, 201e5, 201e6, 201e7 thin portion
201f1, 201f2, 201f3, 201f4, 201f5, 201f7 thick portion
201g seal portion
201h seat-side end portion
201j seat-side end portion
201k straight line
201m expansion portion
201o1, 201o2, 201o3, 201o4 recess portion
202 valve (relief valve)
203 valve holder
205 relief body
205a press-fit portion
205b hole

1. A high-pressure fuel supply pump, comprising:
a relief valve mechanism configured so as to open to release a high-pressure fuel when fuel on a discharge side of a pressurizing chamber becomes equal to or greater than a set value, and having a relief seat member on which a relief valve is seated, wherein
the relief seat member of the relief valve mechanism has,
on an inner peripheral side of the relief seat member, a seat portion on which the relief valve is seated, a small-diameter channel portion formed with a smaller diameter than the relief valve on an upstream side of the seat portion, and a large-diameter channel portion formed with a larger diameter than the small-diameter channel portion on an upstream side of the small-diameter channel portion, and
on an outer peripheral side of the relief seat member, a fine gap portion formed between the relief seat member of the relief valve mechanism and a member arranged on the outer peripheral side of the relief seat member at a position overlapping the small-diameter channel portion in a flow direction of the fuel, and a press-fit portion coming into contact with the member when the relief seat member is press-fitted into the member at a position overlapping the large-diameter channel portion in the flow direction of the fuel.

2. A high-pressure fuel supply pump, comprising:
a relief valve mechanism configured so as to open to release a high-pressure fuel when fuel on a discharge side of a pressurizing chamber becomes equal to or greater than a set value, and having a relief seat member on which a relief valve is seated, wherein
the relief seat member of the relief valve mechanism has
a seat portion on which the relief valve is seated, a thick portion formed on an upstream side of the seat portion, a thin portion formed on an upstream side of the thick portion and being thinner than the thick portion, and a press-fit portion formed on an upstream side of the thin portion and coming into contact with a member arranged on an outer peripheral side of the relief seat member when the relief seat member is press-fitted into the member.

3. The high-pressure fuel supply pump according to claim 2, wherein
the relief seat member of the relief valve mechanism is configured such that a flow direction length of the fuel in the thin portion is larger than a flow direction length of the fuel in the thick portion.

4. The high-pressure fuel supply pump according to claim 2, wherein
the relief seat member of the relief valve mechanism has a fine gap portion formed between an outer peripheral portion of the thick portion and an outer peripheral portion of the thin portion and a member arranged on an outer peripheral side of the relief seat member.

5. The high-pressure fuel supply pump according to claim 2, wherein
the relief seat member of the relief valve mechanism has a small-diameter channel portion formed with a smaller diameter than the relief valve on an inner peripheral side of the thick portion, and a large-diameter channel portion formed with a larger diameter than the small-diameter channel portion on an inner peripheral side of the thin portion and an inner peripheral side of the press-fit portion.

6. The high-pressure fuel supply pump according to claim 1, wherein
the fine gap portion of the relief seat member is formed such that a distance with the member arranged on the outer peripheral side of the relief seat member is equal to or less than 0.2 mm.

7. The high-pressure fuel supply pump according to claim 1, wherein
the relief seat member of the relief valve mechanism is configured such that, when viewed from a cross section in the flow direction of the fuel, a seat-side end portion of an outer peripheral portion of the large-diameter channel portion of the relief seat member is positioned on an outer peripheral side with respect to a straight line drawn from the seat portion to a seat-side end portion of the press-fit portion of the relief seat member.

8. The high-pressure fuel supply pump according to claim 1, wherein
the relief seat member of the relief valve mechanism is configured such that a flow direction length of the fuel of the small-diameter channel portion is smaller than a flow direction length of the fuel of the fine gap portion.

9. The high-pressure fuel supply pump according to claim 1, wherein
the relief seat member of the relief valve mechanism is configured such that a flow direction length of the fuel of the large-diameter channel portion is larger than a flow direction length of the fuel of the press-fit portion.

10. The high-pressure fuel supply pump according to claim 1, wherein
the relief seat member of the relief valve mechanism has an expansion portion connected with the small-diameter channel portion and the large-diameter channel portion of the relief seat member and expending from the small-diameter channel portion toward the large-diameter channel portion.

11. The high-pressure fuel supply pump according to claim 10, wherein
the relief seat member of the relief valve mechanism is configured such that the expansion portion is configured in a tapered shape and a taper angle of the expansion portion is larger than a seat angle of the seat portion.

12. The high-pressure fuel supply pump according to claim 10, wherein
the relief seat member of the relief valve mechanism is configured such that a flow direction length of the fuel of the expansion portion of the relief seat member is smaller than a flow direction length of the fuel of the small-diameter channel portion.

13. The high-pressure fuel supply pump according to claim 1, wherein
the relief seat member of the relief valve mechanism is press-fitted directly into a pump body or press-fitted indirectly via a relief body into the pump body.

14. The high-pressure fuel supply pump according to claim 1, comprising:
a suction valve arranged on a suction side of the pressurizing chamber; and
a discharge valve arranged on a discharge side of the pressurizing chamber, wherein
the relief seat member of the relief valve mechanism is configured to return fuel to the pressurizing chamber or a low-pressure space on an upstream side of the suction valve when fuel on a downstream side of the discharge valve becomes equal to or greater than a set value.

15. The high-pressure fuel supply pump according to claim 1, comprising:
a relief spring biasing the relief valve toward the seat portion of the relief seat member.
